(19) United States
(12) Patent Application Publication
(10) Pub. No.: US 2021/0234286 A1
(43) Pub. Date: Jul. 29, 2021

(54) TERMINAL

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Tetsuya MIYAMURA, Mie (JP); Masaaki TABATA, Mie (JP)

(21) Appl. No.: 16/967,550

(22) PCT Filed: Feb. 4, 2019
(86) PCT No.: PCT/JP2019/003793

§ 371 Date: Aug. 5, 2020

(30) Foreign Application Priority Data
Feb. 15, 2018 (JP) 2018-025419

(51) Int. Cl. H01R 4/18; H01R 4/50

(52) U.S. Cl. CPC H01R 4/18; H01R 4/5066

(57) ABSTRACT

A female terminal 12 is connected to an electrical wire 11, and provided with: an electrical wire connection 19 having a base 22, and first and second pinching parts 14, 15 that pinch the electrical wire 11 and that extend from the base 22 in the extending direction; and a slide part 18 that is slidable with respect to the electric wire connection 19 along the extending direction (back-and-forth direction). The slide part 18 has a first slope 44 and a second slope 45 that deform the first and second pinching parts 14, 15 toward the electrical wire 11 and that change the deformation amounts of the first and second pinching parts 14, 15 in accordance with the moving amount of the slide part 18 along the back-and-forth direction with respect to the electrical wire connection 19. The electrical wire connection 19 has a first boss 40 and a second boss 41, and the slide part 18 has a first guide groove 42 with which the first boss 40 is engaged and a second guide groove 43 with which the second boss 41 is engaged.

### TECHNICAL FIELD

The technique disclosed in the present specification relates to a terminal.

### BACKGROUND

Conventionally, terminals are known that are connected to the core exposed from an end of an electrical wire. Such a terminal includes a crimp portion that is externally crimped to the core exposed from the end of the electrical wire.

To crimp the above-described terminal to the electrical wire, the following may be performed, for example. First, a metal plate material is pressed to form a terminal having a predetermined shape. Subsequently, the terminal is placed on a placement portion of a lower mold, located on the lower side, of a pair of molds, which are movable relative to each other in a vertical direction. Subsequently, the core exposed from the end of the electrical wire is placed overlapping the crimp portion of the metal terminal. Then, by moving either or both of the pair of molds in a direction in which they approach each other so that the crimp portion is interposed between a crimp portion of the upper mold and the placement portion of the lower mold, the crimp portion is crimped to the core of the electrical wire. With this measure, the terminal is connected to the end of the electrical wire (see Patent Document 1).

### PRIOR ART DOCUMENT

Patent Document
Patent Document 1: JP 2005-050736A

### SUMMARY OF THE INVENTION

### Problems to be Solved

However, the above-described technique needs the molds for crimping the crimp portion of the terminal to the core of an electrical wire, which requires investment in facility, causing the problem that the manufacturing cost will increase.

In order to solve the above-described problem, a terminal is conceivable that includes a pair of supporting portions that support an electrical wire with the electrical wire interposed therebetween. A core is arranged between the pair of supporting portions of this terminal, and a sliding portion is slid in a direction in which the electrical wire is lead out from the terminal, the sliding portion including a pressing portion that presses the pair of supporting portions against the core. As a result of the pressing portion pressing the pair of supporting portions against the core, and the pair of supporting portions supporting the core with the core interposed therebetween, it is expected that the terminal and the electrical wire are connected to each other.

However, according to the above-described configuration, if a core having a different standard is used, it will be necessary to change the design of the sliding portion according to the standard. This will increase the number of components, causing the problem that the manufacturing cost of the terminal increases.

The technique disclosed in the present specification was made in view of the above-described circumstances, and it is an object of the present invention to reduce the manufacturing cost of a terminal.

### Means to Solve the Problem

According to the technique disclosed in the present specification, a terminal to be connected to an electrical wire includes: a wire connection portion that includes a base portion, and a supporting portion that extends from the base portion in an extending direction and supports the electrical wire; and a sliding portion that is slidable with respect to the wire connection portion in the extending direction, wherein at least one of the wire connection portion and the sliding portion includes a pressing portion that deforms the supporting portion toward the electrical wire, and changes an amount of deformation of the supporting portion based on an amount of movement of the sliding portion with respect to the wire connection portion in the extending direction.

With the above-described configuration, it is possible to change the amount of deformation of the supporting portion in a direction toward the electrical wire, based on the amount of movement of the sliding portion. With this, one terminal of a standard can cover electrical wires of different standards. As a result, an increase in the number of components can be suppressed, making it possible to reduce the manufacturing cost of the terminal.

Note that the phrase “slidable in the extending direction” encompasses a case where the sliding portion slides in parallel to the extending direction, as well as a case where the sliding portion slides in a direction that is not in parallel to the extending direction but substantially conforms to the extending direction.

As embodiments of the technique disclosed in the present specification, the following aspects are preferable.

Preferably, the pressing portion includes an inclined surface that is provided on a surface of the sliding portion that faces the supporting portion, and is inclined in the extending direction.

With the above-described configuration, since the inclined surface provided on the sliding portion can press the supporting portion, it is possible to reliably exert a pressing force to the supporting portion.

Preferably, the pressing portion includes a boss that protrudes from the supporting portion toward the sliding portion, and a guide groove that is formed in the sliding portion and receives the boss, and the guide groove extends in the extending direction while being inclined.

With the above-described configuration, by adjusting the shape of the guide groove, it is possible to easily adjust the amount of deformation of the supporting portion.

Preferably, at least one of the wire connection portion and the sliding portion includes a provisional engagement portion configured to keep relative positions of the wire connection portion and the sliding portion at a provisional engagement position, at which the supporting portion does not press the core wire, and a proper engagement portion configured to keep the relative positions of the wire connection portion and the sliding portion at a proper engagement position, at which the supporting portion presses the core wire, and the proper engagement portion includes a large deformation engagement portion that deforms the supporting portion by a relatively large amount of deformation, and a small deformation engagement portion that deforms the supporting portion by a relatively small amount of deformation.

With the above-described configuration, it is possible to cover electrical wires of different standards, by engaging the wire connection portion with the sliding portion using the large deformation engagement portion or the small deformation engagement portion.

Preferably, in a state in which the sliding portion is held at the provisional engagement position with respect to the wire connection portion, an extending end portion of the supporting portion is arranged at a position such that the supporting portion largely opens relative to the base portion as the supporting portion approaches the extending end portion from the base portion in the extending direction.

With the above-described configuration, since the extending end portion of the supporting portion is arranged at a position such that the supporting portion largely opens relative to the base portion, an operation for inserting the electrical wire into the wire connection portion can be performed easily. Therefore, it is possible to improve the efficiency of an operation for connecting the terminal and the electrical wire.

### Effect of the Invention

According to the technique disclosed in the present specification, it is possible to reduce the manufacturing cost of a terminal.

### BRIEF DESCRIPTION OF THE DRAWINGS

FIG. 1 is a perspective view illustrating a terminal-equipped wire according to Embodiment 1.

FIG. 2 is a cross-sectional view illustrating the terminal-equipped wire.

FIG. 3 is a perspective view illustrating a tubular connection portion, an extended portion, and a wire connection portion.

FIG. 4 is a side view illustrating the tubular connection portion, the extended portion, and the wire connection portion.

FIG. 5 is a plan view illustrating the tubular connection portion, the extended portion, and the wire connection portion.

FIG. 6 is a back view illustrating the extended portion and the wire connection portion.

FIG. 7 is a perspective view illustrating a sliding portion.

FIG. 8 is a side view illustrating the sliding portion.

FIG. 9 is a back view illustrating the sliding portion.

FIG. 10 is a perspective view illustrating a state in which the sliding portion is held at a provisional engagement position with respect to the wire connection portion.

FIG. 11 is a side view illustrating the state in which the sliding portion is held with respect to the wire connection portion at the provisional engagement position.

FIG. 12 is a cross-sectional view illustrating the state in which the sliding portion is held with respect to the wire connection portion at the provisional engagement position.

FIG. 13 is a side view illustrating the state in which the sliding portion is held with respect to the wire connection portion at the provisional engagement position, with an electrical wire inserted therethrough.

FIG. 14 is a cross-sectional view illustrating the state in which the sliding portion is held with respect to the wire connection portion at the provisional engagement position, with an electrical wire inserted therethrough.

FIG. 15 is a side view illustrating a state in which the sliding portion is held at a large deformation engagement position with respect to the wire connection portion.

FIG. 16 is a side view illustrating a state in which the sliding portion is held at a small deformation engagement position with respect to the wire connection portion.

FIG. 17 is a cross-sectional view illustrating the state in which the sliding portion is held at the small deformation engagement position with respect to the wire connection portion.

### DETAILED DESCRIPTION TO EXECUTE THE INVENTION

### Embodiment 1

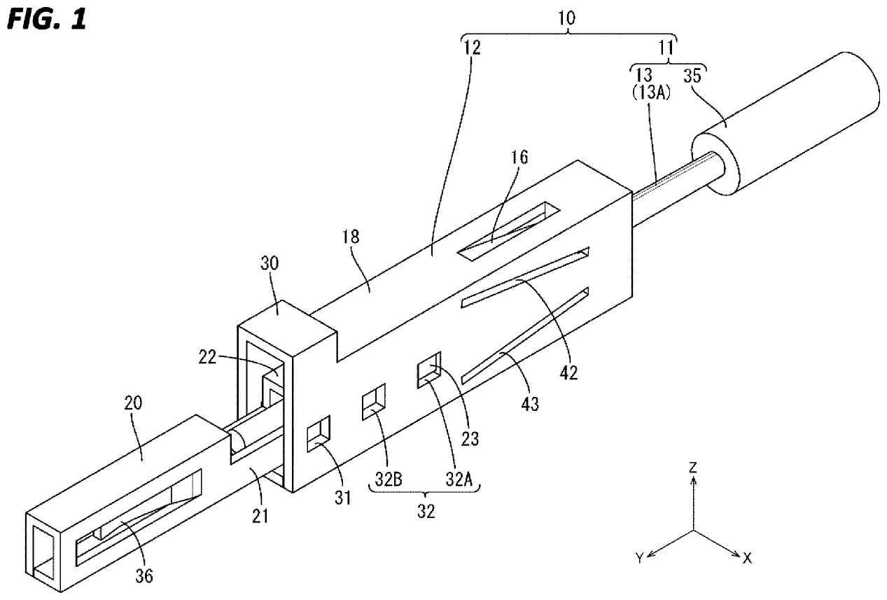

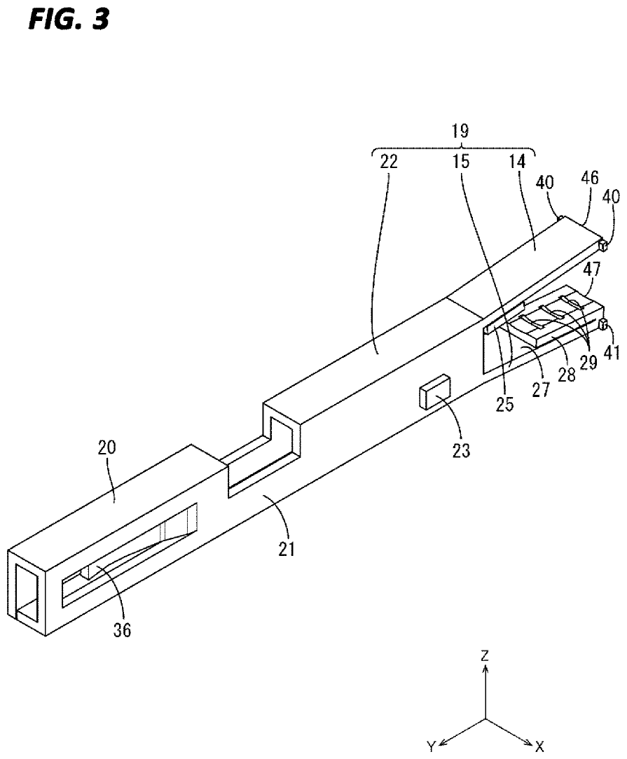

Embodiment 1 of the technique disclosed in the present specification will be described with reference to FIGS. 1 to 17. A terminal-equipped wire 10 according to the present embodiment includes an electrical wire 11, and a female terminal 12 (an example of a terminal) connected to the electrical wire 11. The following description will be made assuming that the “Z” direction refers to an upward direction, the “Y” direction refers to a forward direction, and the “X” direction refers to a leftward direction. Also, a reference numeral may be given to only some of a plurality of the same members, and may be omitted for the remaining members.

Electrical Wire 11

As shown in FIG. 1, the electrical wire 11 is provided with a core 13, and an insulating covering 35 that covers the outer circumference of the core 13 and is made of an insulating synthetic resin. As the core 13, a small-diameter core 13A with a relatively small diameter, or a large-diameter core 13B with a relatively large diameter can be selected. As the metal of which the core 13 is made, any type of metal such as copper, a copper alloy, aluminum, or an aluminum alloy can be suitably selected according to the need. The core 13 according to the present embodiment is made of copper or a copper alloy. The core 13 may be a twisted wire obtained by twisting a plurality of metal bar wires, or a single core made of one rod-shaped metal material. The core 13 according to the present embodiment is made of a single core.

Female Terminal 12

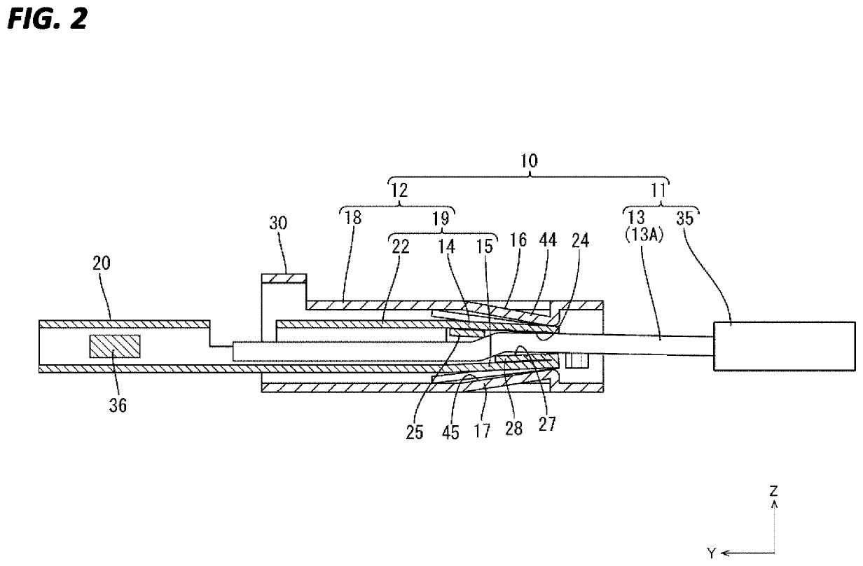

As shown in FIG. 2, the female terminal 12 includes: a wire connection portion 19 that has a first supporting portion 14 (an example of a supporting portion) and a second supporting portion 15 (an example of the supporting portion) that support the core 13 of the electrical wire 11 with the core 13 interposed therebetween; and a sliding portion 18 slidably attached to the wire connection portion 19.

The female terminal 12 is made of a conductive metal material. As the metal of which the female terminal 12 is made, any type of metal such as copper, a copper alloy, aluminum, or an aluminum alloy can be suitably selected according to the need. The terminal according to the present embodiment is made of copper or a copper alloy. The female terminal 12 can be formed using a well-known method such as cutting, casting, or pressing.

The female terminal 12 has a tubular connection portion 20 into which a not-shown male terminal is to be inserted. The tubular connection portion 20 is square tubular extending in a front-rear direction. The tubular connection portion 20 is open to the front and rear sides. The tubular connection portion 20 has, on the left side wall thereof, an elastic contact piece 36 that protrudes to the inside of the tubular connection portion 20. The elastic contact piece 36 extends forward from a position near the rear end portion of the tubular connection portion. As a result of the elastic contact piece 36 coming into elastic contact with the male terminal, the male terminal and the female terminal 12 are electrically connected to each other.

An extended portion 21 is contiguous from the rear end portion of the tubular connection portion 20, the extended portion 21 extending rearward. The wire connection portion 19 is contiguous from the rear end portion of this extended portion 21. The wire connection portion 19 includes a base portion 22, and the first supporting portion 14 and the second supporting portion 15 that extend from the rear end portion of the base portion 22 to the rear side (an example of an extending direction).

The extended portion 21 is open to the upper side. Accordingly, the core 13 arranged inside the extended portion 21 can be viewed from above.

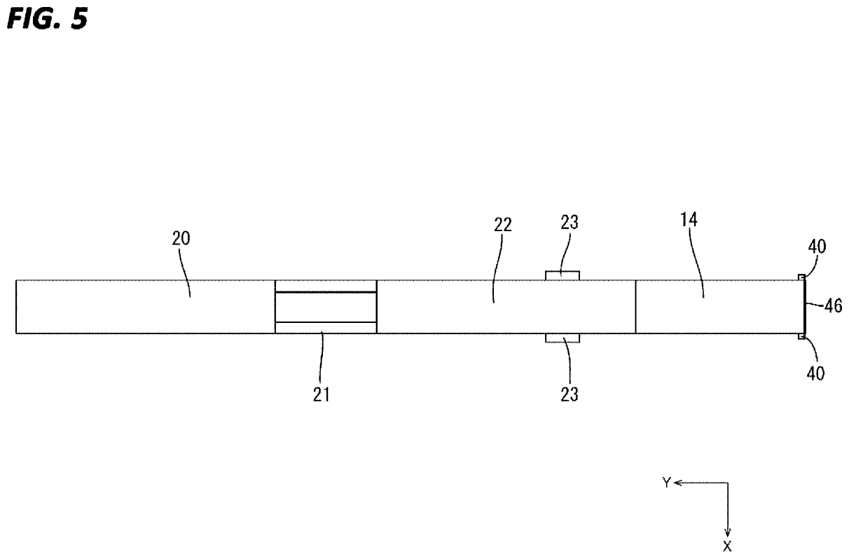

The base portion 22 is square tubular extending in the front-rear direction. The base portion 22 is open to the front and rear sides. The base portion 22 has, on the left side wall and the right side wall thereof, engaging protrusions 23 that respectively protrude in the left and right directions (see FIG. 5).

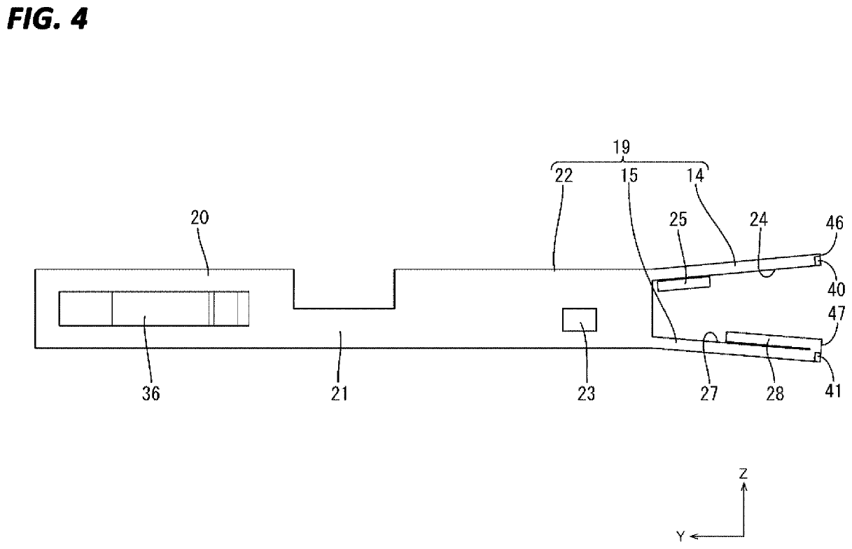

As shown in FIG. 4, the first supporting portion 14 extends from the rear end portion of the upper wall of the base portion 22 in a direction of obliquely upward and rearward (an example of an extending direction). A first extending end portion 46 of the first supporting portion 14 is located on the upper side of the rear end portion of the base portion 22. In other words, the first extending end portion 46 of the first supporting portion 14 is arranged at a position such that the first supporting portion 14 largely opens relative to the rear end portion of the base portion 22 in the front-rear direction. The first supporting portion 14 is planer in an elongated shape extending in the front-rear direction. The first supporting portion 14 is flexurally deformable with respect to the plate thickness direction (vertical direction).

The first extending end portion 46 of the first supporting portion 14 has, at both the left and right ends thereof, two first bosses 40 that respectively protrude outward in the left and right directions. The dimension of the protrusion of the first bosses 40 protruding from the side edges of the first supporting portion in the left and right directions is substantially the same as the thickness of both left and right side walls of the sliding portion 18. The phrase “substantially the same” encompasses a case where the dimension of the protrusion of the first bosses 40 is the same as the thickness of both left and right side walls of the sliding portion 18, and a case where the dimension of the protrusion of the first bosses 40 is not the same as this thickness but is regarded as being substantially the same as this thickness.

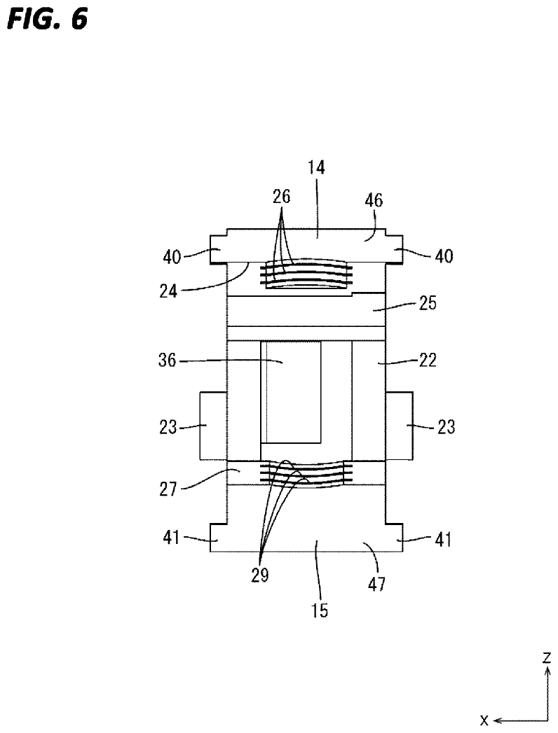

The lower surface of the first supporting portion 14 serves as a first contact surface 24 configured to come into contact with the core 13. The first supporting portion 14 has, at a position near the front end portion thereof, a first projection 25 that protrudes downward from the first contact surface 24. The first contact surface 24 of the first supporting portion 14 has, at positions on the rear side of the first projection 25, a plurality of first serrations 26, which extend in the left and right direction and are arranged at intervals in the front-rear direction, each of the first serrations 26 being shaped in a V groove (see FIG. 6).

As shown in FIG. 4, the second supporting portion 15 extends from the rear end portion of the lower wall of the base portion 22 in a direction of obliquely downward and rearward (an example of the extending direction). A second extending end portion 47 of the second supporting portion 15 is located on the lower side of the rear end portion of the base portion 22. In other words, the second extending end portion 47 of the second supporting portion 15 is arranged at a position such that the second supporting portion 15 largely opens relative to the rear end portion of the base portion 22 in the front-rear direction. The second supporting portion 15 is planer in an elongated shape extending in the front-rear direction. The second supporting portion 15 is flexurally deformable with respect to the plate thickness direction (vertical direction).

The second extending end portion 47 of the second supporting portion 15 has, at both the left and right ends thereof, two second bosses 41 that respectively protrude outward in the left and right directions. The dimension of the protrusion of the second bosses 41 protruding from the side edges of the second supporting portion in the left and right directions is substantially the same as the thickness of both left and right side walls of the sliding portion 18. The phrase “substantially the same” encompasses a case where the dimension of the protrusion of the second bosses 41 is the same as the thickness of both left and right side walls of the sliding portion 18, and a case where the dimension of the protrusion of the second bosses 41 is not the same as this thickness but is regarded as being substantially the same as this thickness.

The upper surface of the second supporting portion 15 serves as a second contact surface 27 configured to come into contact with the core 13. The second contact surface 27 of the second supporting portion 15 has a second projection 28 that protrudes upward from the second contact surface 27, at a position on the rear side of the rear end portion of the first projection of the first supporting portion 14. The second projection 28 includes, on the upper surface thereof, a plurality of second serrations 29, which extend in the left and right direction and are arranged at intervals in the front-rear direction, each of the second serrations 29 being shaped in a V groove (see FIG. 6).

Sliding Portion 18

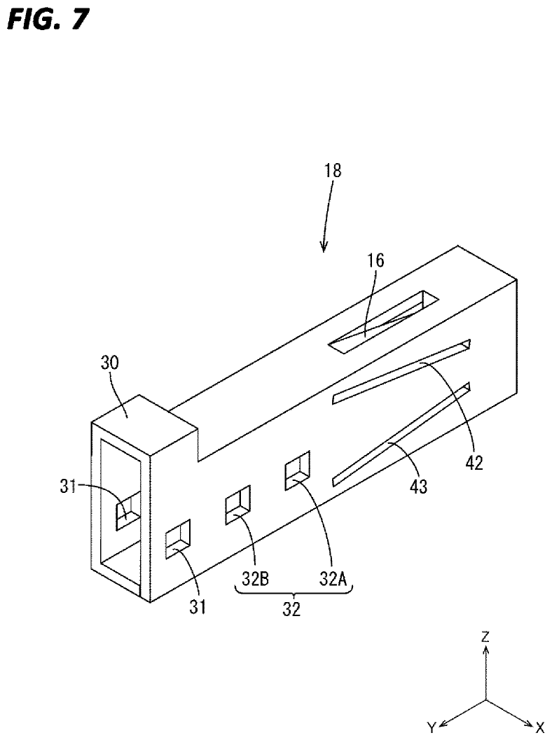

As shown in FIG. 7, the sliding portion 18 has an elongated square tubular shape extending in the front-rear direction, and is open to the front and rear sides. The front-side opening of the sliding portion 18 has the same shape as the outer shape of the wire connection portion 19 or slightly larger than this outer shape, so that the wire connection portion 19 can be inserted thereinto. The sliding portion 18 can be made of a suitable material such as metal, synthetic resin, or a ceramic material according to the need. As the metal of which the sliding portion 18 is made, any type of metal such as copper, a copper alloy, aluminum, an aluminum alloy, or a stainless steel can be suitably selected according to the need. If the sliding portion 18 is formed using metal, a suitable method such as cutting, casting, or pressing can be used according to the need.

The sliding portion 18 has, in the front end portion of the upper wall thereof, a tool abutting portion 30 that protrudes upward. As a result of this tool abutting portion 30 being pressed from behind by a tool 34, the sliding portion 18 slides to the front.

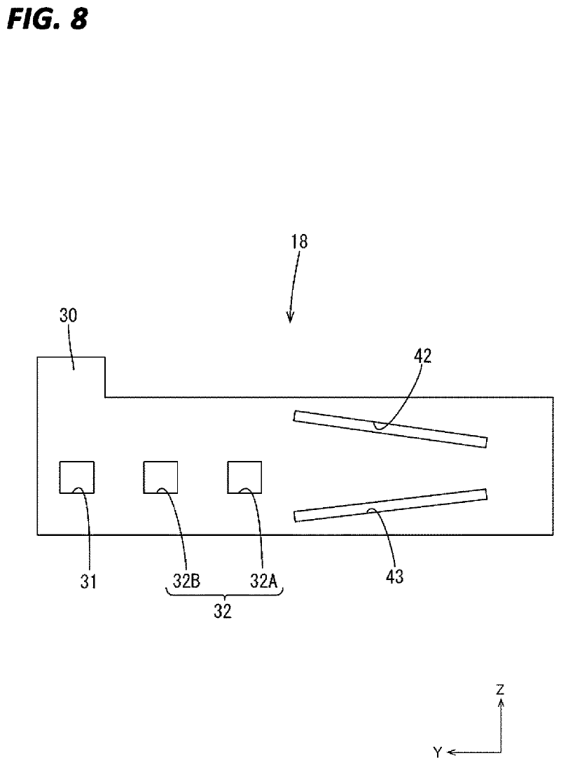

As shown in FIGS. 7 and 8, the sliding portion 18 has, at positions near the front end portions of the left side wall and the right side wall thereof, provisional engagement portions 31 that elastically engage with the engaging protrusions 23 so that the sliding portion 18 is held at a provisional engagement position with respect to the wire connection portion 19. The provisional engagement portions 31 are formed as through holes that respectively penetrate the left side wall and the right side wall of the sliding portion 18. The hole edges of the provisional engagement portions 31 have the same size as that of the engaging protrusions 23 or are slightly larger than this, so that the engaging protrusions 23 can be fitted into the provisional engagement portions 31.

The left side wall and the right side wall of the sliding portion 18 each have, at positions on the rear side of the corresponding provisional engagement portion 31, a plurality of (two in the present embodiment) proper engagement portions 32 arranged side by side in the front-rear direction, the proper engagement portions 32 elastically engaging with the engaging protrusions 23 and holding the sliding portion 18 at a proper engagement position with respect to the wire connection portion 19. The proper engagement portion 32 are formed as through holes that respectively penetrate through the left side wall and the right side wall of the sliding portion 18. The hole edges of the proper engagement portions 32 have the same size as that of the engaging protrusions 23 or are slightly larger than this, so that the engaging protrusions 23 can be fitted into the proper engagement portions 32.

The proper engagement portions 32 provided on each of the side walls of the sliding portion 18 include a large deformation engagement portion 32A located on the rear side, and a small deformation engagement portion 32B located in front of the large deformation engagement portion 32A. As a result of the engaging protrusions 23 engaging with the large deformation engagement portions 32A, the sliding portion 18 is held at a large deformation engagement position with respect to the wire connection portion 19, and as a result of the engaging protrusions 23 engaging with the small deformation engagement portions 32B, the sliding portion 18 is held at a small deformation engagement position with respect to the wire connection portion 19.

First Protruding Portion

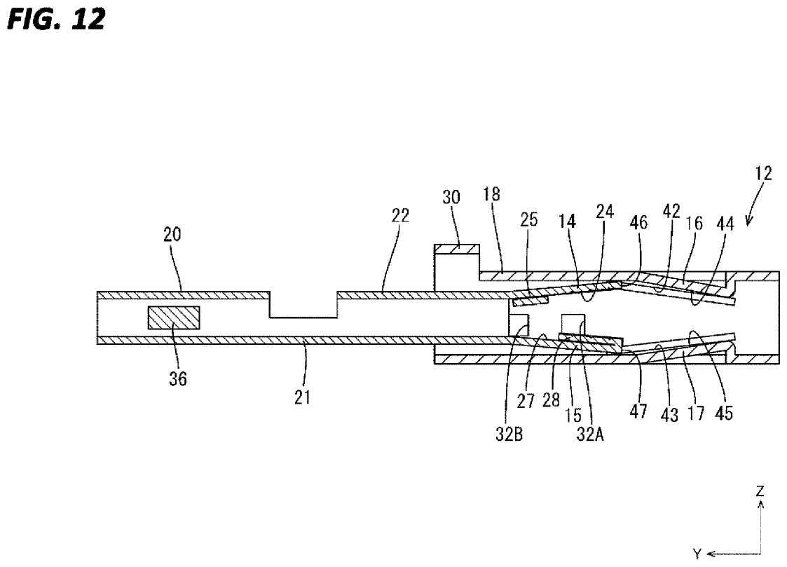

As shown in FIG. 12, the sliding portion 18 has, on the lower surface of the upper wall thereof, a first protruding portion 16 that protrudes downward and extends in the front-rear direction, the first protruding portion 16 being located at a position on the rear side of the central position, in the front-rear direction, of the sliding portion 18. The rear end portion of the first protruding portion 16 reaches a position slightly forward of the rear end portion of the sliding portion 18. The protrusion of the first protruding portion 16 protruding from the upper wall of the sliding portion 18 is set such that the dimension of the protrusion increases toward the rear side. Accordingly, the lower surface of the first protruding portion 16 serves as a first inclined surface 44 (pressing portion, an example of an inclined surface) that is inclined downward toward the rear side. The first inclined surface 44 according to the present embodiment is formed as a flat surface. The first inclined surface 44 faces the lower surface of the first supporting portion 14. Note that the first inclined surface 44 may also be a curved surface.

Second Protruding Portion

The sliding portion 18 has, on the upper surface of the lower wall thereof, a second protruding portion 17 that protrudes upward and extends in the front-rear direction, the second protruding portion 17 being located at a position on the rear side of the central position, in the front-rear direction, of the sliding portion 18. The rear end portion of the second protruding portion 17 reaches a position slightly forward of the rear end portion of the sliding portion 18. The protrusion of the second protruding portion 17 protruding from the lower wall of the sliding portion 18 is set such that the dimension of the protrusion increases toward the rear side. Accordingly, the upper surface of the second protruding portion 17 serves as a second inclined surface 45 (pressing portion, an example of the inclined surface) that is inclined upward toward the rear side. The second inclined surface 45 according to the present embodiment is formed as a flat surface. The second inclined surface 45 faces the upper surface of the second supporting portion. Note that the second inclined surface 45 may also be a curved surface.

The shapes of the first protruding portion 16 and the second protruding portion 17 are such that they are symmetric with respect to the vertical direction. Therefore, the first inclined surface 44 and the second inclined surface 45 are also formed as being symmetric with respect to the vertical direction. Note that the first protruding portion 16 and the second protruding portion 17 may also be asymmetric with respect to the vertical direction.

First Guide Groove 42

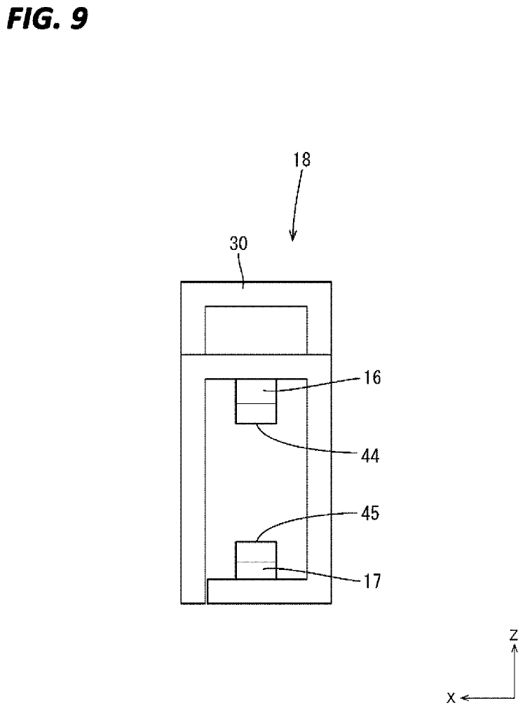

As shown in FIGS. 8 and 9, the left and right side walls of the sliding portion 18 each have, at a position on the upper side of the central position in the vertical direction, a first guide groove 42 (pressing portion, an example of a guide groove). The front end portion of the first guide groove 42 reaches a position forward of the front end portion of the first protruding portion. Also, the rear end portion of the first guide groove 42 reaches a position rearward of the rear end portion of the first protruding portion. The first guide grooves 42 according to the present embodiment are formed penetrating the respective side walls of the sliding portion 18. Note that the first guide grooves 42 do not necessarily need to penetrate the respective side walls of the sliding portion 18.

The first guide grooves 42 are formed inclined downward in a straight line from the front side to the rear side. Note that the first guide groove 42 may also be formed inclined in a downward curve.

The left and right side walls of the sliding portion 18 each have, at a position on the lower side of the central position in the vertical direction, a second guide groove 43 (pressing portion, an example of the guide groove). The front end portion of the second guide groove 43 reaches a position forward of the front end portion of the second protruding portion. Also, the rear end portion of the second guide groove 43 extends to a position rearward of the rear end portion of the second protruding portion. The second guide grooves 43 according to the present embodiment are formed penetrating the respective side walls of the sliding portion 18. Note that the second guide grooves 43 do not necessarily need to penetrate the respective side walls of the sliding portion 18.

The second guide grooves 43 are formed inclined upward in a straight line from the front side to the rear side. Note that the second guide grooves 43 may also be formed inclined in a downward curve.

The shapes of the first guide grooves 42 and the second guide grooves 43 according to the present embodiment are such that they are symmetric with respect to the vertical direction. Note that the first guide grooves 42 and the second guide grooves 43 may also be asymmetric with respect to the vertical direction.

Provisional Engagement State

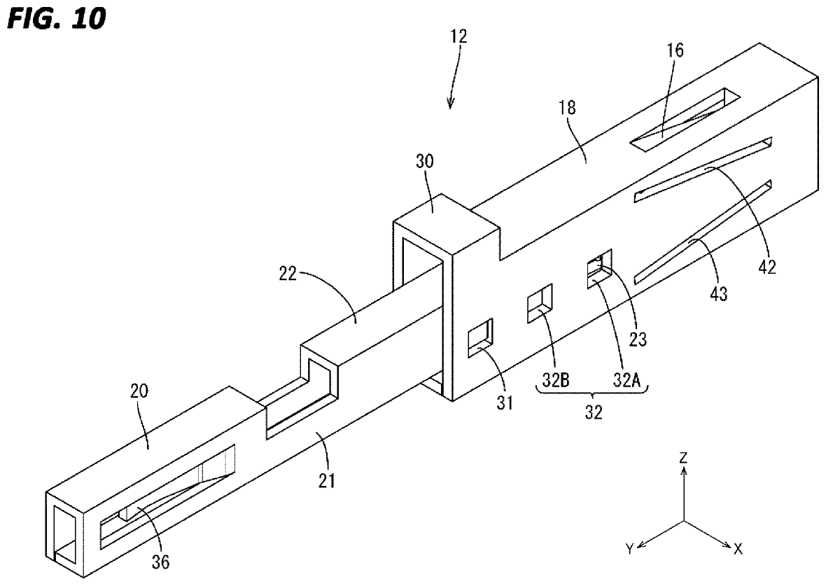

FIGS. 10 to 12 show a state in which the sliding portion 18 is provisionally engaged with the wire connection portion 19. The engaging protrusions 23 of the wire connection portion 19 are internally fitted into the provisional engagement portions 31 of the sliding portion 18. In the state in which the sliding portion 18 is held with respect to the wire connection portion 19 at the provisional engagement position, the front half of the sliding portion 18 is externally fitted to the wire connection portion 19 by about two-thirds of the length from the rear end portion thereof in the front-rear direction.

As shown in FIG. 12, in the provisional engagement state, the rear end portion of the first supporting portion 14 is located in front of the front end portion of the first protruding portion 16. The rear end portion of the second supporting portion 15 is located in front of the front end portion of the second protruding portion 17. In other words, in the provisional engagement state, the first supporting portion 14 and the first protruding portion 16 are not abutting against each other, and the second supporting portion 15 and the second protruding portion 17 are not abutting against each other.

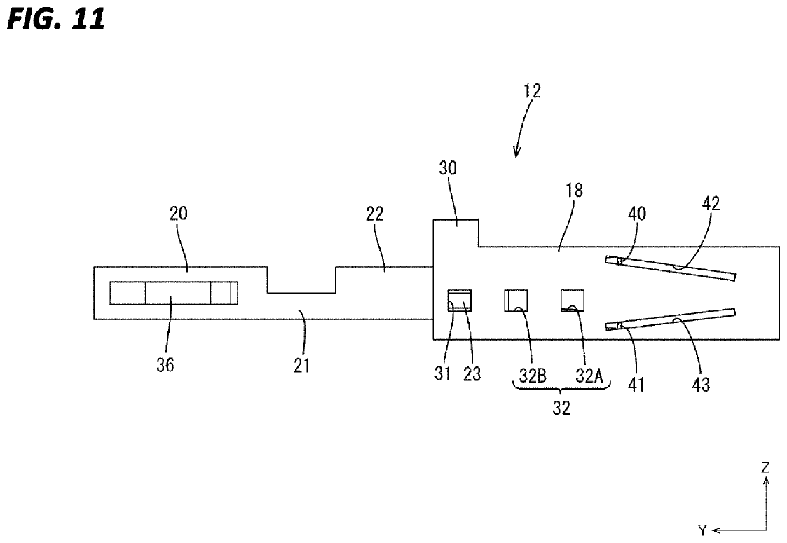

As shown in FIG. 11, in the provisional engagement state, the first bosses 40 of the first supporting portion 14 are fitted into the first guide grooves 42 of the sliding portion 18, and are located at positions slightly rearward of the front end portions of the first guide grooves 42. Similarly, in the provisional engagement state, the second bosses 41 of the second supporting portion 15 are fitted into the second guide grooves 43 of the sliding portion 18, and are located at positions slightly rearward of the front end portions of the second guide grooves 43.

Proper Engagement State (Large Deformation Engagement State)

FIGS. 1 to 2 and 15 show a state in which the sliding portion 18 is properly engaged with the large deformation engagement portions 32A of the wire connection portion 19. The engaging protrusions 23 of the wire connection portion 19 are internally fitted into the large deformation engagement portions 32A of the sliding portion 18. In the state in which the sliding portion 18 is held at the large deformation engagement position with respect to the wire connection portion 19, the sliding portion 18 completely covers the wire connection portion 19 in the front-rear direction. The front end portion of the sliding portion 18 is located at a position forward of the front end portion of the wire connection portion 19, and the rear end portion of the sliding portion 18 is located at a position rearward of the rear end portion of the wire connection portion 19.

When the sliding portion 18 is properly engaged with the large deformation engagement portions 32A of the wire connection portion 19, the small-diameter core 13A, that is, a core 13 whose diameter is relatively small, will be used.

As shown in FIG. 2, the first protruding portion 16 abuts against the upper surface (surface opposite to the first contact surface 24) of the first supporting portion 14 from above. Accordingly, the first supporting portion 14 is pushed downward, and abuts against the small-diameter core 13A from above.

The second protruding portion 17 abuts against the lower surface (surface opposite to the second contact surface 27) of the second supporting portion 15 from below. Accordingly, the second supporting portion 15 is pushed upward, and abuts against the small-diameter core 13A from below.

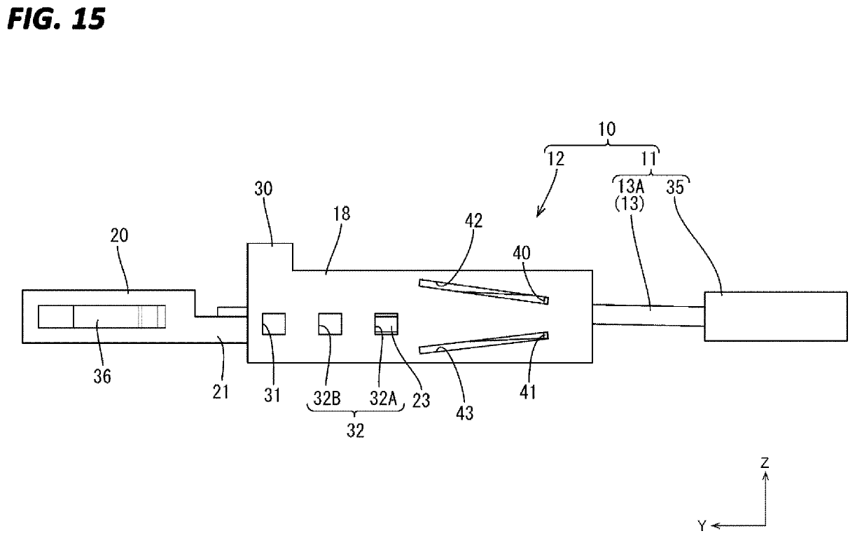

Furthermore, as shown in FIG. 15, at the large deformation engagement position, the first bosses 40 are located at rear end portions of the first guide grooves 42. Accordingly, the first extending end portion 46 of the first supporting portion 14 deforms downward, and thereby the first supporting portion 14 abuts against the small-diameter core 13A from above.

At the large deformation engagement position, the second bosses 41 are located at rear end portions of the second guide grooves 43. Accordingly, the second extending end portion 47 of the second supporting portion 15 deforms upward, and thereby the second supporting portion 15 abuts against the small-diameter core 13A from above.

As a result of the first supporting portion 14 being pressed by the first protruding portion 16 from above, and the second supporting portion 15 being pressed by the second protruding portion 17 from below, the small-diameter core 13A arranged between the first supporting portion 14 and the second supporting portion 15 is supported by the first supporting portion 14 and the second supporting portion 15. Accordingly, the electrical wire 11 and the female terminal 12 are electrically connected to each other.

As shown in FIG. 2, the small-diameter core 13A is cranked by being interposed between the first projection 25 of the first supporting portion 14 and the second projection 28 of the second supporting portion 15, which are provided shifted from each other in the front-rear direction. Accordingly, the small-diameter core 13A is firmly supported between the first supporting portion 14 and the second supporting portion 15.

As a result of the first contact surface 24 of the first supporting portion 14 being pressed against the core 13, the small-diameter core 13A is fitted into the first serrations 26 formed in the first contact surface 24. Accordingly, an oxide layer formed on the surface of the small-diameter core 13A is stripped and a metal surface is exposed. The exposed metal surface comes into contact with the first contact surface 24, thereby making it possible to reduce the electric resistance between the first supporting portion 14 and the small-diameter core 13A.

Similarly, as a result of the second contact surface 27 of the second supporting portion 15 being pressed against the small-diameter core 13A, the small-diameter core 13A is fitted into the second serrations 29 formed in the second contact surface 27. Accordingly, an oxide layer formed on the surface of the small-diameter core 13A is stripped and a metal surface is exposed. The exposed metal surface comes into contact with the second contact surface 27, thereby making it possible to reduce the electric resistance between the second supporting portion 15 and the small-diameter core 13A.

Proper Engagement State (Small Deformation Engagement State)

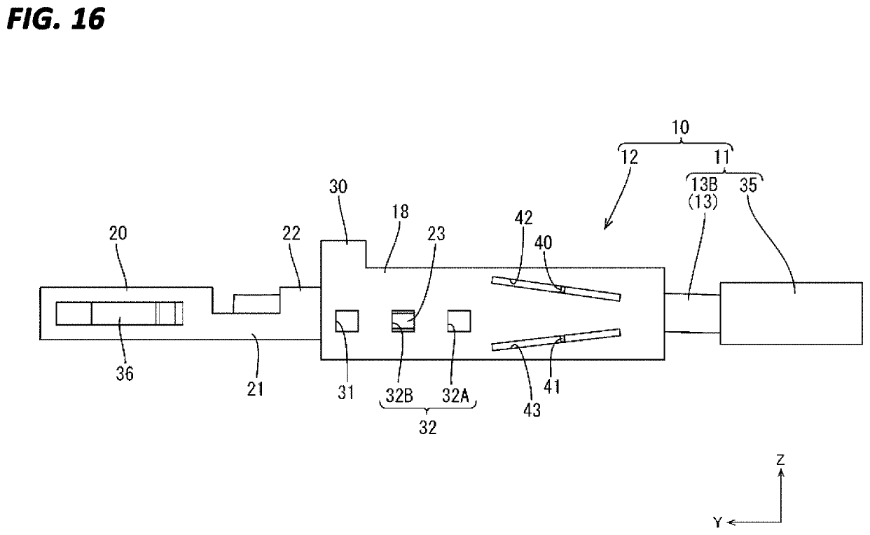

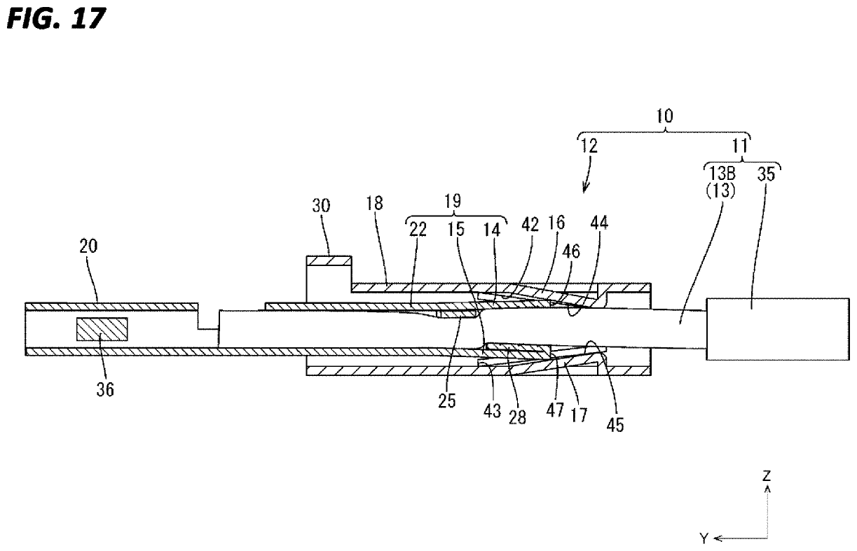

FIGS. 16 and 17 show a state in which the sliding portion 18 is properly engaged with the small deformation engagement portion 32B of the wire connection portion 19. The engaging protrusions 23 of the wire connection portion 19 are internally fitted into the small deformation engagement portions 32B of the sliding portion 18. In the state in which the sliding portion 18 is held at the small deformation engagement position with respect to the wire connection portion 19, the front end portion of the wire connection portion 19 protrudes forward of the front end portion of the sliding portion 18, and the rear end portion of the wire connection portion 19 is located at a position forward of the rear end portion of the sliding portion 18.

When the sliding portion 18 is properly engaged with the small deformation engagement portions 32B of the wire connection portion 19, the large-diameter core 13B, that is, a core 13 whose diameter is larger than that of the small-diameter core 13A, will be used.

As shown in FIG. 17, the first protruding portion 16 abuts against the upper surface (surface opposite to the first contact surface 24) of the first supporting portion 14 from above. Accordingly, the first supporting portion 14 is pushed downward, and abuts against the large-diameter core 13B from above.

The second protruding portion 17 abuts against the lower surface (surface opposite to the second contact surface 27) of the second supporting portion 15 from below. Accordingly, the second supporting portion 15 is pushed upward, and abuts against the large-diameter core 13B from below.

Furthermore, as shown in FIG. 16, at the small deformation engagement position, the first bosses 40 are located at positions near the central position, in the front-rear direction, of the first guide grooves 42. Accordingly, the first extending end portion 46 of the first supporting portion 14 deforms downward, and thereby the first supporting portion 14 abuts against the large-diameter core 13B from above.

At the small deformation engagement position, the second bosses 41 are located at positions near the central position, in the front-rear direction, of the second guide grooves 43. Accordingly, the second extending end portion 47 of the second supporting portion 15 deforms upward, and thereby the second supporting portion 15 abuts against the large-diameter core 13B from above.

As a result of the first supporting portion 14 being pressed by the first protruding portion 16 from above, and the second supporting portion 15 being pressed by the second protruding portion 17 from below, the large-diameter core 13B arranged between the first supporting portion 14 and the second supporting portion 15 is supported by the first supporting portion 14 and the second supporting portion 15. Accordingly, the electrical wire 11 and the female terminal 12 are electrically connected to each other.

The amount of deformation of the first supporting portion 14 to the lower side, and the amount of deformation of the second supporting portion 15 to the upper side are smaller when they are at the small deformation engagement position than when they are at the large deformation engagement position. Therefore, it is possible to apply an appropriate pressing force to the large-diameter core 13B.

As shown in FIG. 17, the large-diameter core 13B is cranked by being interposed between the first projection 25 of the first supporting portion 14 and the second projection 28 of the second supporting portion 15, which are provided shifted from each other in the front-rear direction. Accordingly, the large-diameter core 13B is firmly supported between the first supporting portion 14 and the second supporting portion 15.

As a result of the first contact surface 24 of the first supporting portion 14 being pressed against the large-diameter core 13B, the large-diameter core 13B is fitted into the first serrations 26 formed in the first contact surface 24. Accordingly, an oxide layer formed on the surface of the large-diameter core 13B is stripped and a metal surface is exposed. The exposed metal surface comes into contact with the first contact surface 24, thereby making it possible to reduce the electric resistance between the first supporting portion 14 and the large-diameter core 13B.

Similarly, as a result of the second contact surface 27 of the second supporting portion 15 being pressed against the large-diameter core 13B, the large-diameter core 13B is fitted into the second serrations 29 formed in the second contact surface 27. Accordingly, an oxide layer formed on the surface of the large-diameter core 13B is stripped and a metal surface is exposed. The exposed metal surface comes into contact with the second contact surface 27, thereby making it possible to reduce the electric resistance between the second supporting portion 15 and the large-diameter core 13B.

### Example of Process for Connecting Female Terminal 12 and Electrical Wire 11

The following will describe an example of a process for connecting the female terminal 12 and the electrical wire 11 according to the present embodiment. Note that the process for connecting the female terminal 12 and the electrical wire 11 is not limited to the description below.

First, the sliding portion 18 is externally fitted to the wire connection portion 19 of the female terminal 12 from behind. The rear end portion of the wire connection portion 19 of the female terminal 12 is inserted into the front-side opening of the sliding portion 18, and the sliding portion 18 is moved forward. When the first bosses 40 of the first supporting portion 14 and the second bosses 41 of the second supporting portion 15 abut against the edge of the front-side opening of the sliding portion 18 from the front, the left and right side walls of the sliding portion 18 elastically deform outward in the left and right directions. When the sliding portion 18 is moved further forward, the engaging protrusions 23 of the wire connection portion 19 abut against the edge of the front-side opening of the sliding portion 18 from the front. Accordingly, the left and right side walls of the sliding portion 18 elastically deform outward in the left and right directions.

When the sliding portion 18 is moved further forward, the first bosses 40 are fitted into the first guide grooves 42, the second bosses 41 are fitted into the second guide grooves 43, and the engaging protrusions 23 are fitted into the provisional engagement portions 31, so that the left and right side walls of the sliding portion 18 flexibly return. As a result of the engaging protrusions 23 abutting against the hole edges of the provisional engagement portions 31 from the front or behind, the sliding portion 18 is held with respect to the wire connection portion 19 at the provisional engagement position. Furthermore, the first extending end portion 46 of the first supporting portion 14 and the second extending end portion 47 of the second supporting portion 15 are held at positions such that the supporting portions largely open relative to the rear end portion of the base portion 22 (see FIGS. 10 to 12).

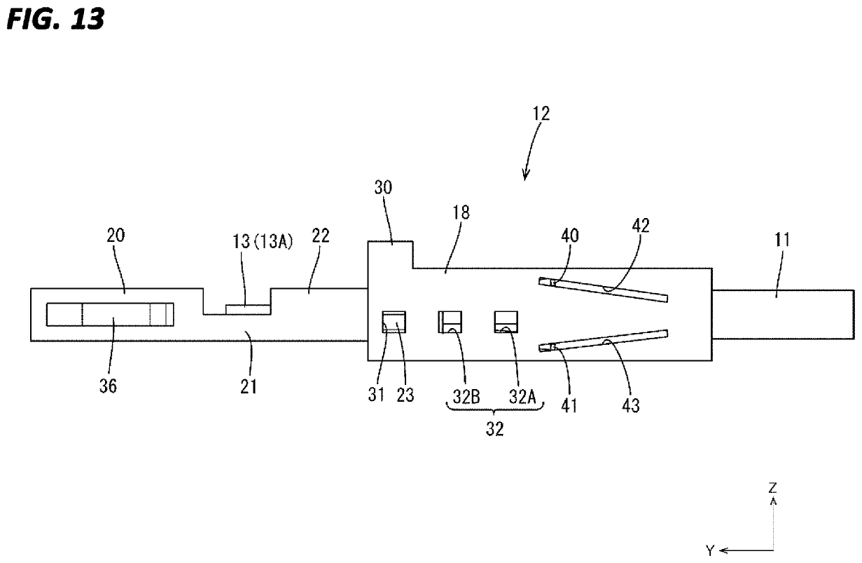

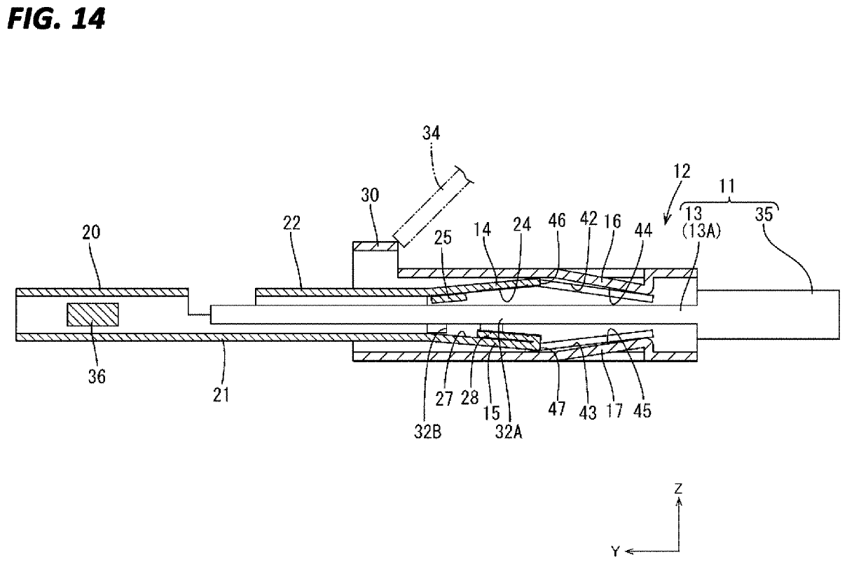

Then, the insulating covering 35 is stripped at an end of the electrical wire 11 so that the small-diameter core 13A is exposed. As shown in FIGS. 13 and 14, the exposed small-diameter core 13A is inserted into the rear-side opening of the sliding portion 18. The small-diameter core 13A is further inserted forward, so that the front end portion of the small-diameter core 13A is located inside the extended portion 21. An operator can view with his or her eyes the extended portion 21 from above to determine whether the front end portion of the small-diameter core 13A is located inside the extended portion 21.

As shown in FIG. 14, by bringing the tool 34 into contact with the tool abutting portion 30 from behind and pressing the tool abutting portion 30 from behind, the sliding portion 18 is moved forward. As a result, the left and right side walls of the sliding portion 18 run over the engaging protrusions 23 of the wire connection portion 19. Accordingly, the left and right side walls of the wire connection portion 19 elastically deform inward in the left and right direction. When the sliding portion 18 is moved further forward, the first protruding portion 16 abuts against the upper surface of the first supporting portion 14 from above, and the second protruding portion 17 abuts against the lower surface of the second supporting portion 15 from below.

When the sliding portion 18 is moved further forward, the first inclined surface 44 of the first protruding portion 16 presses the first supporting portion 14 downward from above, and the second inclined surface 45 of the second protruding portion 17 presses the second supporting portion 15 upward from below. Accordingly, the first supporting portion 14 deforms downward and the second supporting portion 15 deforms upward, and thereby the small-diameter core 13A is interposed between and supported by the first supporting portion 14 and the second supporting portion 15.

Furthermore, as a result of the first bosses 40 moving to the rear side within the first guide grooves 42, the first supporting portion 14 deforms downward. Furthermore, as a result of the second bosses 41 moving to the rear side within the second guide grooves 43, the second supporting portion 15 deforms upward. Accordingly, the small-diameter core 13A is interposed between and is supported by the first supporting portion 14 and the second supporting portion 15.

When the sliding portion 18 is moved further forward, the engaging protrusions 23 are fitted into the large deformation engagement portions 32A, and the left and right side walls of the wire connection portion 19 flexibly return. Accordingly, the engaging protrusions 23 abut against the hole edges of the large deformation engagement portion 32A from the front or behind, and thereby the sliding portion 18 is held at the large deformation engagement position with respect to the wire connection portion 19 (see FIGS. 1 to 2, and 15). Consequently, the operation for connecting the female terminal 12 and the electrical wire 11 is ended, and thereby the terminal-equipped wire 10 is complete.

On the other hand, the procedure to be performed if the female terminal 12 is connected to the electrical wire 11 having the large-diameter core 13B is the same as the above-described procedure, except for a step for holding the sliding portion 18 at the small deformation engagement position with respect to the wire connection portion 19, and thus a description thereof is omitted (see FIGS. 16 and 17).

### Functions and Effects of the Present Embodiment

Hereinafter, the functions and effects of the present embodiment will be described. The female terminal 12 according to the present embodiment is to be connected to the electrical wire 11, and includes: the wire connection portion 19 that has the base portion 22, and the first supporting portion 14 and the second supporting portion 15 that extends from the base portion 22 in the extending direction and support the electrical wire 11 with the electrical wire 11 interposed therebetween; and the sliding portion 18 that is slidable with respect to the wire connection portion 19 in the extending direction (front-rear direction), the sliding portion 18 including the first inclined surface 44 and the second inclined surface 45 that respectively deform the first supporting portion 14 and the second supporting portion 15 toward the electrical wire 11, and change an amount of deformation of the first supporting portion 14 and an amount of deformation of the second supporting portion 15 based on an amount of movement of the sliding portion 18 with respect to the wire connection portion 19 in the front-rear direction. Also, the wire connection portion 19 includes the first bosses 40 and the second bosses 41, and the sliding portion 18 includes the first guide grooves 42 with which the first bosses 40 are to engage, and the second guide grooves 43 with which the second bosses 41 are to engage.

According to the above-described configuration, the amounts of deformation of the first supporting portion 14 and the second supporting portion 15 in a direction in which it approaches the electrical wire 11 can be changed based on the amount of movement of the sliding portion 18. Accordingly, one female terminal 12 of a standard can cover electrical wires 11 of different standards. As a result, an increase in the number of components can be suppressed, making it possible to reduce the manufacturing cost of the female terminal 12.

Note that the phrase “slidable in the extending direction” encompasses a case where the sliding portion slides in parallel to the extending direction, as well as a case where the sliding portion slides in a direction that is not in parallel to the extending direction but substantially conforms to the extending direction.

Furthermore, according to the present embodiment, the sliding portion 18 includes the first inclined surface 44 that faces the first supporting portion 14, and the second inclined surface 45 that faces the second supporting portion 15. As a result of the first supporting portion 14 being pressed by the first inclined surface 44, and the second supporting portion 15 being pressed by the second inclined surface 45, the first supporting portion 14 and the second supporting portion 15 can reliably exert a pressing force.

Also, according to the present embodiment, the first supporting portion 14 includes the first bosses 40, and the second supporting portion 15 includes the second bosses 41. On the other hand, the sliding portion has the first guide grooves 42 with which the first bosses 40 are to engage, and the second guide grooves 43 with which the second bosses 41 are to engage. The first guide grooves 42 and the second guide grooves 43 extend inclined in the extending direction (front-rear direction).

With the above-described configuration, by adjusting the shapes of the first guide grooves 42 and the second guide grooves 43, it is possible to easily adjust the amounts of deformation of the first supporting portion and the second supporting portion.

Furthermore, according to the present embodiment, the sliding portion 18 includes the provisional engagement portions 31 that keep the relative positions of the wire connection portion 19 and the sliding portion 18 at the provisional engagement position at which the first supporting portion 14 and the second supporting portion 15 do not press the core 13, and the proper engagement portions 32 that keep the relative positions of the wire connection portion 19 and the sliding portion 18 at the proper engagement position at which the first supporting portion 14 and the second supporting portion 15 press the core 13. The proper engagement portion 32 includes the large deformation engagement portions 32A that deform the first supporting portion 14 and the second supporting portion 15 by relatively large amounts of deformation, and small deformation engagement portions 32B that deform the first supporting portion 14 and the second supporting portion 15 by relatively small amounts of deformation.

With the above-described configuration, it is possible to cover electrical wires 11 of different standards, by engaging the wire connection portion 19 with the sliding portion 18 using the large deformation engagement portions 32A or the small deformation engagement portions 32B.

Furthermore, according to the present embodiment, in a state in which the sliding portion 18 is held with respect to the wire connection portion 19 at the provisional engagement position, the first extending end portion 46 of the first supporting portion 14 and the second extending end portion 47 of the second supporting portion 15 are arranged at positions such that the supporting portions largely open relative to the base portion 22 as the supporting portions approaches the rear side from the base portion 22.

With the above-described configuration, since the first extending end portion 46 of the first supporting portion 14 and the second extending end portion 47 of the second supporting portion 15 are arranged at positions such that the supporting portions largely open relative to the base portion 22, an operation for inserting the electrical wire 11 into the wire connection portion 19 can be performed easily. Therefore, it is possible to improve the efficiency of an operation for connecting the female terminal 12 and the electrical wire 11.

### OTHER EMBODIMENTS

The technique disclosed in the present specification is not limited to the embodiment explained in the above description with reference to the drawings, and the technical scope of the technique disclosed in the present specification encompasses, for example, the following embodiments.

(1) Although, in the above-described embodiment, the female terminal 12 is used as a terminal, but the present invention is not limited to this, and may use a male terminal, a round terminal, or a splice terminal for connecting a plurality of electrical wires 11.

(2) Although, in the above-described embodiment, the electrical wire 11 is a covered wire, but the electrical wire 11 may be a naked wire. The electrical wire 11 may also be a twisted wire obtained by twisting a plurality of metal thin wires together.

(3) Although, in the above-described embodiment, the female terminal 12 includes the first supporting portion 14 and the second supporting portion 15, but the present invention is not limited to this, and may include one supporting portion, or three or more supporting portions.

(4) Although, in the above-described embodiment, the base portion 22 has the shape of a square tube, but the present invention is not limited to this, and may use a base portion 22 in the shape of a circular tube, or the shape of a polygonal tube, such as a triangular tube, or a hexagonal tube. Furthermore, the sliding portion 18 may also have the shape of a circular tube, or the shape of a polygonal tube, such as a triangular tube.

(5) The pressing portion may only have inclined surfaces. The pressing portion may also have only guide grooves and bosses.

(6) Although, in the above-described embodiment, the proper engagement portions 32 include the large deformation engagement portions 32A and the small deformation engagement portions 32B, but the present invention is not limited to this. A configuration is also possible in which three or more proper engagement portions are provided depending on the amount of deformation of the supporting portion.

(7) The above-described embodiment has described the case where the core 13 is the large-diameter core 13B and the case where the core 13 is the small-diameter core 13A, but the present invention is not limited to these cases. Even in a case where, due to different materials of cores 13, the pressing forces appropriate for the cores 13 are different, the technique described in the present specification can be used as appropriate.

### LIST OF REFERENCE NUMERALS

11: Electrical wire
12: Female terminal
14: First supporting portion
15: Second supporting portion
18: Sliding portion
19: Wire connection portion
22: Base portion
31: Provisional engagement portion
32A: Large deformation engagement portion
32B: Small deformation engagement portion
40: First boss
41: Second boss
42: First guide groove
43: Second guide groove
44: First inclined surface
46: First extending end portion
47: Second extending end portion
45: Second inclined surface

1. A terminal to be connected to an electrical wire, comprising:
a wire connection portion that includes a base portion, and a supporting portion that extends from the base portion in an extending direction and supports the electrical wire; and
a sliding portion that is slidable with respect to the wire connection portion in the extending direction,
wherein at least one of the wire connection portion and the sliding portion includes a pressing portion that deforms the supporting portion toward the electrical wire, and changes an amount of deformation of the supporting portion based on an amount of movement of the sliding portion with respect to the wire connection portion in the extending direction.

2. The terminal according to claim 1,
wherein the pressing portion includes an inclined surface that is provided on a surface of the sliding portion that faces the supporting portion, and is inclined in the extending direction.

3. The terminal according to claim 1,
wherein the pressing portion includes a boss that protrudes from the supporting portion toward the sliding portion, and a guide groove that is formed in the sliding portion and receives the boss, and
the guide groove extends in the extending direction while being inclined.

4. The terminal according to claim 1,
wherein at least one of the wire connection portion and the sliding portion includes a provisional engagement portion configured to keep relative positions of the wire connection portion and the sliding portion at a provisional engagement position, at which the supporting portion does not press the electrical wire, and a proper engagement portion configured to keep the relative positions of the wire connection portion and the sliding portion at a proper engagement position, at which the supporting portion presses the electrical wire, and
the proper engagement portion includes a large deformation engagement portion that deforms the supporting portion by a relatively large amount of deformation, and a small deformation engagement portion that deforms the supporting portion by a relatively small amount of deformation.

5. The terminal according to claim 4,
wherein, in a state in which the sliding portion is held at the provisional engagement position with respect to the wire connection portion, an extending end portion of the supporting portion is arranged at a position such that the supporting portion largely opens relative to the base portion as the supporting portion approaches the extending end portion from the base portion in the extending direction.
